(19) United States
(12) Patent Application Publication
(10) Pub. No.: US 2007/0167058 A1
(43) Pub. Date: Jul. 19, 2007

(54) Check valve and method of forming a check valve

(76) Inventors: Jan W. M. Mijers, Heemstede (NL); Brendan Hogan, Gort (IE)

Correspondence Address: BRINKS HOFER GILSON & LIONE, P.O. BOX 10395, CHICAGO, IL, 60610, US

(21) Appl. No.: 11/643,472

(22) Filed: Dec. 20, 2006

Related U.S. Application Data
(63) Continuation of application No. PCT/EP05/06645, filed on Jun. 20, 2005.

(30) Foreign Application Priority Data
Jun. 21, 2004 (DE) DE202004009722.2

(51) Int. Cl. H01R 13/28

(52) U.S. Cl. 439/288

(57) ABSTRACT

A check valve is provided, including a first hose connector housing defining an entry passage, a second hose connector housing engaging the first hose connector housing and defining an exit passage, a generally flexible perforate membrane disk positioned between the first and second hose connector housings for selectively sealingly separating the first and second hose connector housings from each other, and an overmolded component connecting the first and second hose connector housings with each other.

### CROSS-REFERENCE TO RELATED APPLICATION

This patent application is a continuation of International Application PCT/EP2005/006645 published as PCT patent application WO 2005/123177 A1, with an international filing date of Jun. 20, 2005 and entitled “CHECK VALVE,” which claims the benefit of priority to German patent application DE 20 2004 009 722.2, filed Jun. 21, 2004 and entitled “Rüickschlagventil,” the entire contents of each of which are incorporated herein by reference.

### FIELD OF THE INVENTION

This invention relates to a check valve and a method of forming a check valve, such as a check valve suited for medical applications.

### BACKGROUND

Check valves may be used to selectively fluidly connect a first hose with a second hose. More specifically, check valves known in the art may be used to permit fluid flow in a first direction and to prevent or restrict flow in a second, opposite direction. One such known check valve includes a first hose connector housing, a second hose connector housing, and a membrane disk of flexible material positioned between the two hose connector housings. The membrane disk is selectively sealingly seated on a valve seat to selectively separate the first and second hoses from each other. Specifically, when unaffected by external forces the membrane disk is seated on the valve seat. However, when a sufficient external force acts on the membrane disk, such as fluid pressure from fluid flowing along the first hose, the membrane disk becomes unseated and permits fluid connection between the first and second hoses. More specifically, the membrane disk defines openings located radially outwardly from the valve seat that permit fluid flow therethrough when the membrane disk is unseated, thereby connecting the first and second hoses. Such a design is disclosed European patent 0 612 537, the entire contents of which are incorporated herein by reference.

Typically, such known check valves are assembled by forming the two hose connector housings by a suitable method such as injection molding, clamping the membrane disk between the hose connector housings, and connecting the hose connector housings with each other by ultrasonic welding or adhesives. This method of manufacturing may have certain disadvantages because the hose connector housings have to be manually handled and assembled in separate working steps, and is therefore an inefficient manufacturing process.

In addition, at each separate working step, one or more inspections may occur for each part as well as the final assembly operation, which may increase the labor costs and therefore the overall assembly costs.

It is therefore desirable to provide a check valve that meets applicable standards, that is relatively simple and economical to manufacture, that substantially consistently forms a seal between the two hose connector housings, and that prevents or minimizes undesired contamination or polluting of the membrane disk or the other components of the check valve.

### BRIEF SUMMARY

This invention seeks to address the above-mentioned shortcomings of the prior art. A check valve is provided, including a first hose connector housing defining an entry passage, a second hose connector housing engaging the first hose connector housing and defining an exit passage, a generally flexible perforate membrane disk positioned between the first and second hose connector housings for selectively sealingly separating the first and second hose connector housings from each other, and an overmolded component connecting the first and second hose connector housings with each other.

In one aspect, the overmolded component is injection molded over the first and second hose connector housings. The overmolded component may be formed of a plastic material.

In another aspect, the overmolded component is an annular ring disposed about an outer periphery of the first and second hose connector housings. The overmolded component may generally define a C-shaped cross-section. Additionally, the overmolded component may enclose laterally projecting margins of the first and second hose connector housings.

In yet another aspect, the first and second hose connector housings each include a centering means for aligning the first and second hose connector housings with each other. The centering means may include an annular projection extending from a face of one of the first and second hose connector housings and an annular groove formed in a face of the other of the first and second hose connector housings.

In another aspect, a method of assembling a check valve is provided, including forming a first hose connector housing defining an entry passage, forming a second hose connector housing defining an exit passage, providing a generally flexible membrane disk such that, when the first and second hose connector housings are coupled with each other, the membrane disk is between the first and second hose connector housings and the membrane disk selectively sealingly separates the first and second hose connector housings, and injection molding an overmolded component over portions of the first and second hose connector housings to connect the connector housings with each other.

In yet another aspect, the step of forming the first hose connector housing includes injection-mold-forming the first and second hose connector housings. The step of providing the membrane disk may occur before the step of forming the first hose connector housing and the step of forming the second hose connector housing. The step of providing the membrane disk may include positioning the membrane disk within a mold for forming one of the first and second hose connector housings.

The above-described aspects may lead to a substantial advantage by reducing polluting and/or damage that may occur during assembly of the check valve. Additionally, the above-described aspects may lead to a substantial advantage by substantially consistently forming a seal between the two hose connector housings.

### BRIEF DESCRIPTION OF THE DRAWINGS

FIG. 1 is a partial-section, schematic view of an embodiment; and

FIG. 2 is a partial-section, schematic view of another embodiment.

### DETAILED DESCRIPTION OF THE DRAWINGS AND THE PRESENTLY PREFERRED EMBODIMENTS

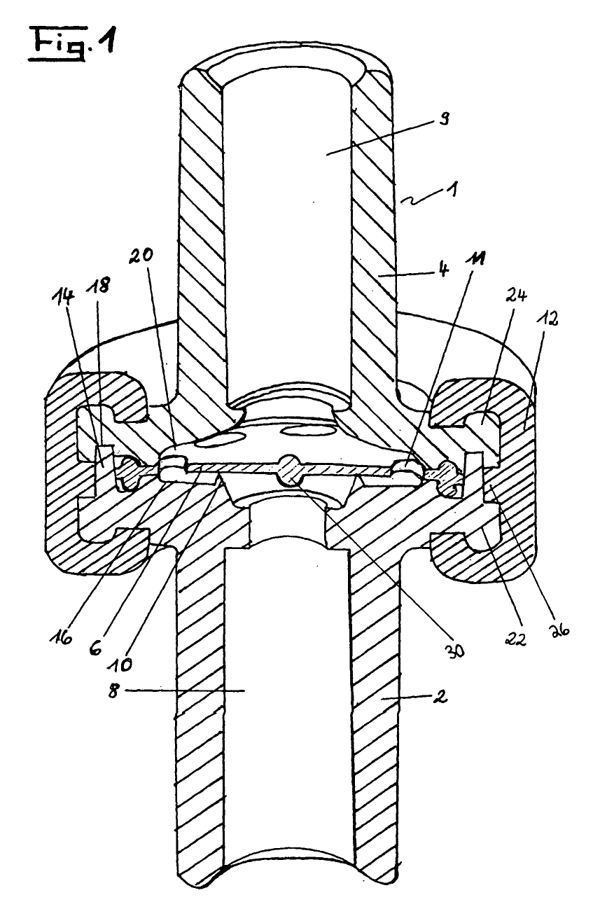

Referring now to a first embodiment, FIG. 1 shows a check valve 1 generally including a first hose connector housing 2, a second hose connector housing 4, a perforate membrane disk 6 positioned between the housings 2, 4, and an overmolded component 12 connecting the first and second hose connector housings 2, 4 with each other. The membrane disk 6 is preferably made of a flexible material such as silicone, silicone rubber, or rubber.

The membrane disk 6, which functions as an overpressure valve, is positioned in an entry passage 8 and selectively forms a seal with an annular valve seat 10 surrounding the entry passage 8. For example, when in its normal state and no external forces are acting thereon, the membrane disk 6 is seated on the valve seat 10 so as to fluidly separate the entry passage 8 and an outlet passage 9. However, when the pressure within the entry passage 8 increases to a particular level, the membrane disk 6 becomes unseated and fluidly connects the entry passage 8 and the outlet passage 9. More specifically, the membrane disk 6 includes a plurality of openings 11 located radially outwardly from the valve seat 10 such that the unseated membrane disk 6 fluidly connects the entry passage 8 and the outlet passage 9 via the openings 11. With a decrease of pressure in the entry passage 8 below a particular value defined by the construction, the membrane disk 6 will return to the valve seat 10 safely and in minimal time such that a flow back from the exit passage 9 to the entry passage 8 may be excluded.

As is discussed further below, the two hose connector housings 2, 4 shown in FIG. 1 are connected with each other by the overmolded component 12. For example, the two hose connector housings 2, 4 may be connected by injection molding the overmolded component 12 within an injection mold.

The two hose connector housings 2, 4 each preferably include centering means for aligning the housings 2, 4 with each other. For example, the centering means shown in FIG. 1 include an annular projection 14 extending from the front face 16 of the first hose connector housing and an annular groove 18 formed in the front face 20 of the second hose connector housing 4. When the two hose connector housings 2, 4 are assembled, the annular projection 14 sits within the annular groove 18 to properly align and temporarily secure the housings 2, 4 with each other.

The overmolded component 12 is positioned over the annular engagement line of the two hose connector housings 2, 4 to secure the housings 2, 4 together. For example, the overmolded component 12 shown in FIG. 1 is an annular ring disposed about an outer periphery of the first and second hose connector housings 2, 4. The overmolded component 12 generally defines a C-shaped cross-section and encloses the two disk-like laterally projecting margins 22 and 24 of the two hose connector housings 2, 4. As shown in FIG. 1, the C-shaped cross-section may include an upper protrusion and a lower protrusion wrapped around the projecting margins 22, 24 and a central protrusion 26 extending radially inwardly. This design creates a generally secure engagement and a substantially or completely fluid-tight seal between the two hose connector housings 2, 4.

The two hose connector housings 2, 4 are preferably formed by injection molding. In the preferred exemplary embodiments according to FIG. 1, the two hose connector housings 2, 4 are produced by injection molding a plastic material and then aligned via the centering means which facilitate the assembly of the hose connector housings 2, 4 in the correct position. The membrane disk 6 may be positioned between the two hose connector housings 2, 4 before or after the formation thereof. More specifically, in one method, the membrane disk 6 may be positioned within a mold such that the membrane disk 6 will be properly aligned and secured to the housing when the housing is formed. Alternatively, the membrane disk 6 may be properly positioned with respect to an already-formed housing. Next, while the two hose connector housings 2, 4 are properly aligned and engaged, the overmolded component is injection molded over the housings 2, 4.

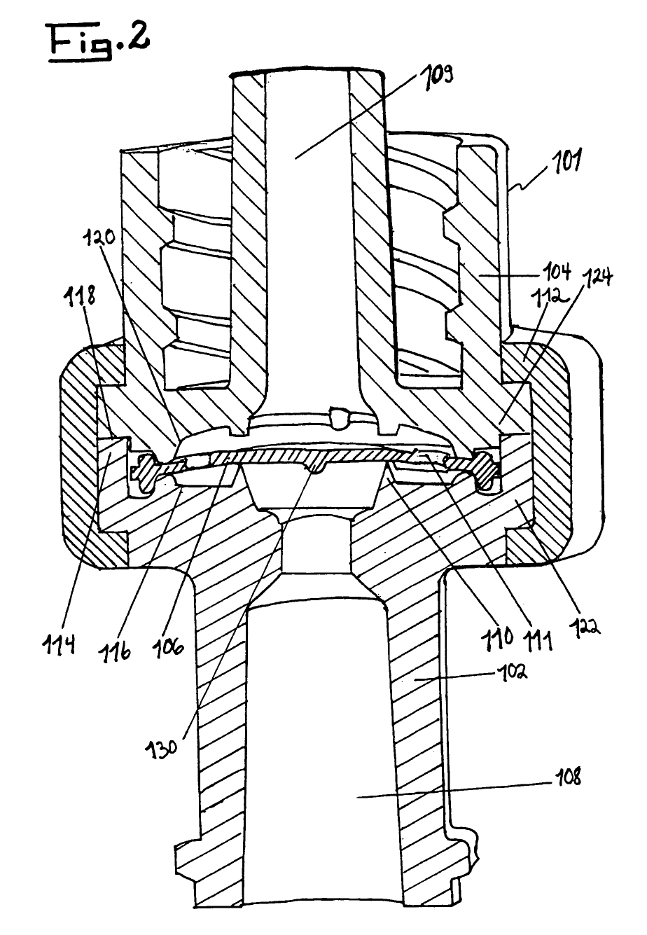

Referring now to a second embodiment, FIG. 2 shows a check valve 101 generally including a first hose connector housing 102, a second hose connector housing 104, a membrane disk 106 positioned between the housings 102, 104, and an overmolded component 112 connecting the first and second hose connector housings 102, 104 with each other. The membrane disk 106 is preferably made of a flexible material such as silicone, silicone rubber, or rubber.

The membrane disk 106, which functions as an overpressure valve, is positioned in an entry passage 108 and selectively forms a seal with an annular valve seat 110 surrounding the entry passage 108. For example, when in its normal state and no external forces are acting thereon, the membrane disk 106 is seated on the valve seat 110 so as to fluidly separate the entry passage 108 and an outlet passage 109. However, when the pressure within the entry passage 108 increases to a particular level, the membrane disk 106 becomes unseated and fluidly connects the entry passage 8 and the outlet passage 9. More specifically, the membrane disk 106 includes a plurality of openings 111 located radially outwardly from the valve seat 110 such that the unseated membrane disk 106 fluidly connects the entry passage 108 and the outlet passage 109 via the openings 111. With a decrease of pressure in the entry passage 108 below a particular value defined by the construction, the membrane disk 106 will return to the valve seat 110 safely and in minimal time such that a flow back from the exit passage 109 to the entry passage 108 may be excluded.

As is discussed further below, the two hose connector housings 102, 104 shown in FIG. 2 are connected with each other by the overmolded component 112. For example, the two hose connector housings 102, 104 may be connected by injection molding the overmolded component 112 within an injection mold.

The two hose connector housings 102, 104 each preferably include centering means for aligning the housings 102, 104 with each other. For example, the centering means shown in FIG. 2 include an annular projection 114 extending from the front face 116 of the first hose connector housing 102 and an annular groove 118 formed in the front face 120 of the second hose connector housing 104. When the two hose connector housings 102, 104 are assembled, the annular projection 114 sits within the annular groove 118 to properly align and temporarily secure the housings 102, 104 with each other.

The overmolded component 112 is positioned over the annular engagement line of the two hose connector housings 102, 104 to secure the housings 102, 104 together. For example, the overmolded component 112 shown in FIG. 2 is an annular ring disposed about an outer periphery of the first and second hose connector housings 102, 104. The overmolded component 112 generally defines a C-shaped cross-section and encloses the two disk-like laterally projecting margins 122 and 124 of the two hose connector housings 102, 104. As shown in FIG. 2, the C-shaped cross-section may include an upper protrusion and a lower protrusion positioned above and below the projecting margins 122, 124, respectively. This design creates a generally secure engagement and a substantially or completely fluid-tight seal between the two hose connector housings 102, 104.

The two hose connector housings 102, 104 are preferably formed by injection molding, as discussed above with respect to the first embodiment shown in FIG. 1. The housings of the embodiments may be comprised of polymeric materials that are generally medically accepted, e.g. polystyrenes, styrenic copolymers (A.B.S.), or polycarbonates.

In spite of the fact that the invention has been described with reference to exemplary embodiments of check valves, it is obvious for the man skilled in the art that the invention is not limited to such applications, but instead each can be used with housing halves, especially housing halves of plastics, that are connected with each other. This may be by way of ultrasonic welding or use of medically approved adhesives (e.g. ultra-violet curing adhesives) or a combination thereof.

A further aspect of the embodiments herein may include providing the membrane disk 6, 106 with a projection 30, 130 that may be on one or both sides of the membrane disk 6, 106. It is believed that the projection 30, 130 prevents or minimizes the occurrence of the membrane disk 6, 106 sticking together during production. For example, if a plurality of disks are manufactured in the same vicinity, or if they are transported adjacent to each other, they may stick together when they come into contact with each other. However, the projections 30, 130 protrude from the disk to minimize the effective contact surface area of the membrane disk 6, 106 so that neighboring membrane disks are less likely to stick to each other if they accidentally contact each other during manufacturing. The projections 30, 130 may be unitary with the membrane disk 6, 106 and may be generally centered relative to the surface area of the membrane disk 6, 106 within the valve seat 10, 110 or generally centered relative to the overall surface area of the membrane disk 6, 106, either accounting for or not accounting for openings 11, 111.

The projections 30, 130 may also be used as an identification means for the membrane disk 6, 106. For example, a part number or other identifier may be stamped or otherwise provided on the projection 30, 130 so that a consumer or other post-market user is able to easily identify the manufacturing and design characteristics of the membrane disk.

It is therefore intended that the foregoing detailed description be regarded as illustrative rather than limiting, and that it be understood that it is the following claims, including all equivalents, are intended to define the spirit and scope of this invention. More particularly, the apparatus and assembly described are merely an exemplary apparatus and assembly, and they are not intended to be limiting.

What is claimed is:

1. A check valve comprising:
a first hose connector housing defining an entry passage;
a second hose connector housing engaging the first hose connector housing and defining an exit passage;
a generally flexible, perforate membrane disk positioned between the first and second hose connector housings and configured to selectively sealingly separate the first and second hose connector housings; and
an overmolded component connecting the first and second hose connector housings with each other.

2. A check valve as in claim 1, wherein the overmolded component is injection molded over the first and second hose connector housings.

3. A check valve as in claim 2, wherein the overmolded component is formed of a plastic material.

4. A check valve as in claim 1, wherein the overmolded component is an annular ring disposed about an outer periphery of the first and second hose connector housings.

5. A check valve as in claim 4, wherein the overmolded component defines a generally C-shaped cross-section.

6. A check valve as in claim 4, wherein the overmolded component encloses laterally projecting margins of the first and second hose connector housings.

7. A check valve as in claim 6, wherein the overmolded component defines a generally C-shaped cross-section.

8. A check valve as in claim 1, wherein the first and second hose connector housings each include a centering means for aligning the first and second hose connector housings with each other.

9. A check valve as in claim 8, wherein the centering means for the first and second hose connector housings include an annular projection extending from a face of one of the first and second hose connector housings and an annular groove formed in a face of the other of the first and second hose connector housings.

10. A check valve as in claim 1, wherein the membrane disk includes a projection.

11. A check valve as in claim 10, wherein the projection is generally centered relative to a surface area of the membrane disk.

12. A method of assembling a check valve, the method comprising:
forming a first hose connector housing defining an entry passage;
forming a second hose connector housing defining an exit passage;
providing a generally flexible, perforate membrane disk such that, when the first and second hose connector housings are coupled with each other, the membrane disk is between the first and second hose connector housings and the membrane disk selectively sealingly separates the first and second hose connector housings; and
injection molding an overmolded component over portions of the first and second hose connector housings.

13. A method as in claim 12, wherein the step of forming the first hose connector housing includes injection-mold-forming the first hose connector housing.

14. A method as in claim 13, wherein the step of forming the second hose connector housing includes injection-mold-forming the second hose connector housing.

15. A method as in claim 14, wherein the step of providing the membrane disk occurs before the step of forming the first hose connector housing and the step of forming the second hose connector housing.

16. A method as in claim 15, wherein the step of providing the membrane disk includes positioning the membrane disk within a mold for forming one of the first and second hose connector housings.

17. A method as in claim 12, wherein the membrane disk includes a projection.

18. A method as in claim 17, further including the step of generally centering the projection in an area of the membrane disk that sealingly separates the first and second hose connector housings.
